(19) United States
(12) Patent Application Publication
(10) Pub. No.: US 2021/0295394 A1
(43) Pub. Date: Sep. 23, 2021

(54) SYSTEMS AND METHODS FOR INCORPORATING VEHICLE VIDEO TESTIMONIALS IN PRICING USED VEHICLES

(71) Applicant: Hosick Motors, Inc, Vandalia, IL (US)

(72) Inventor: Bryan HOSICK, Vandalia, IL (US)

(21) Appl. No.: 16/825,265

(22) Filed: Mar. 20, 2020

(51) Int. Cl. G06Q 30/02; G06Q 30/06; G06F 16/483

(52) U.S. Cl. CPC G06Q 30/0278; G06F 16/483; G06Q 30/0627

(57) ABSTRACT

Systems and methods for incorporating vehicle video testimonials in pricing used vehicles is provided. The system can comprise a processor; an input to the processor for receiving a data file containing vehicle specific information; and a retrieval engine for storing and retrieving the data file, wherein the retrieval engine is configured to parse the data file before storing. The system can further comprise a valuation engine for determining a value of a vehicle using the data file. The valuation engine determines the value of the vehicle using the data file and third-party vehicle pricing information. In some embodiments, the data file is a video file, and in others, the data file comprises at least two of a video file, text file, electronic email, and audio file.

### CROSS REFERENCE TO RELATED APPLICATIONS

The present application claims priority to U.S. Provisional Application Ser. No. 62/820,907, filed Mar. 20, 2019, of which is hereby incorporated by reference in its entireties.

### BACKGROUND

Vehicle pricing companies often rely upon incomplete or inaccurate data when evaluating a trade-in value for a used vehicle. For example, such companies may automatically deduct 12-20% of a vehicle's trade-in value if it has been in a “reported accident,” regardless of the severity of the accident or the excellence in the repairs. A need is to incorporate a more robust and meaningful vehicle history to enable more accurate trade-in evaluations.

### SUMMARY OF INVENTION

Systems and methods for incorporating vehicle video testimonials in pricing used vehicles is provided. In some embodiments, systems comprise a processor; an input to the processor for receiving a data file containing vehicle specific information; and a retrieval engine for storing and retrieving the data file, wherein the retrieval engine is configured to parse the data file before storing.

In some embodiments, the systems further comprise a valuation engine for determining a value of a vehicle using the data file. The valuation engine determines the value of the vehicle using the data file and third-party vehicle pricing information.

In some embodiments, the data file is a video file, and in others, the data file comprises at least two of a video file, text file, electronic email, and audio file.

In some embodiments, the system further comprises a parsing engine for converting the video file to a vehicle purchase file, a vehicle repair file and a vehicle accident file. Metadata, text information, and audio information can be parsed from the data file. In some embodiments, a parsing engine for parsing the video file into a text file, an audio file and an image file, wherein the text file, audio file and image file are all associated with one another.

In some embodiments, methods for providing vehicle information are provided. The methods comprise receiving recorded information about a vehicle; parsing the recorded information into a data file; storing the data file in a database; retrieving a data file from the database; and displaying the data file as part of a vehicle valuation.

In some embodiments the method for receiving recorded information about a vehicle comprises receiving a video file. In certain embodiments, the parsing the recorded information into two or more data files comprise parsing the recorded information into at least two of a video file, text file, electronic email, and audio file. In some embodiments, the step of parsing the video file includes parsing the video file into a vehicle purchase file, a vehicle repair file and a vehicle accident file. In other embodiments, the method includes parsing the recorded information into at least one of a metadata data file, a text data file, and an audio data file. In other embodiments, the method includes parsing the video file into a text file, an audio file and an image file, wherein the text file, audio file and image file are all associated with one another.

### BRIEF DESCRIPTION OF THE DRAWINGS

To facilitate further description of the embodiments, the following drawings are provided in which:

FIG. 1 illustrates a system for capturing, storing and/or retrieving data;

FIG. 2 illustrates an embodiment of the central computer system illustrated in FIG. 1;

FIG. 3 illustrates a method of capturing, storing and retrieving a data file.

### DETAILED DESCRIPTION OF EXAMPLES OF EMBODIMENTS

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

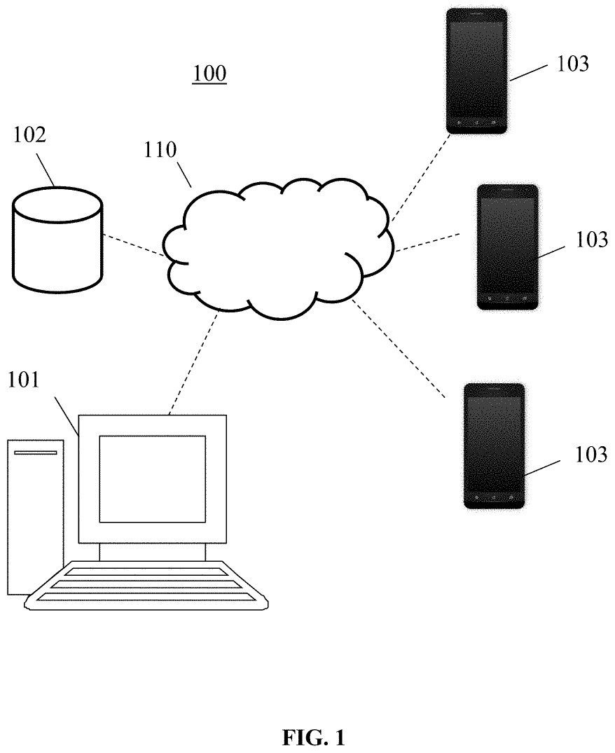

Turning to the drawings, FIG. 1 illustrates an exemplary embodiment of a system 100, all of which or a portion of which can be suitable for (i) implementing part or all of one or more embodiments of the techniques, methods, and systems and/or (ii) implementing and/or operating part or all of one or more embodiments of the vehicle testimony system described herein. For example, in some embodiments, all or a portion of system 100 can be suitable for implementing part or all of one or more embodiments of the techniques, methods, and/or systems described herein. Furthermore, one or more elements of system 100 (e.g., a refreshing monitor, a keyboard, and/or a mouse, etc.) also can be appropriate for implementing part or all of one or more embodiments of the techniques, methods, and/or systems described herein.

In one embodiment, system 100 comprises a computer system 101 and a central database 102. In some embodiments, central computer system 101 can comprise a single computer or server, but in many embodiments, central computer system 101 comprises a cluster or collection of computers or servers and/or a cloud of computers or servers.

In many embodiments, central computer system 101 can comprise a central processing unit (CPU) coupled to a system bus (not shown). In various embodiments, the architecture of tempo can be compliant with any of a variety of commercially distributed architecture families.

In many embodiments, the central computer system 101 is coupled to a memory storage unit (not shown), where the memory storage unit can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, the memory storage unit can comprise (i) non-transitory memory and/or (ii) transitory memory.

The memory storage device(s) of the various embodiments disclosed herein can comprise any type of memory device, including, but not limited to an internal memory storage device, an external memory storage drive, such as, for example, a USB-equipped electronic memory storage drive coupled to universal serial bus (USB) port, a hard drive, an optical disc drive, a floppy disk drive, etc. As used herein, non-volatile and/or non-transitory memory storage device(s) refer to the portions of the memory storage device(s) that are non-volatile and/or non-transitory memory.

In various examples, portions of the memory storage device(s) of the various embodiments disclosed herein (e.g., portions of the non-volatile memory storage device(s)) can comprise an operating system, which can be a software program that manages the hardware and software resources of a computer and/or a computer network. Meanwhile, the operating system can perform basic tasks such as, for example, controlling and allocating memory, prioritizing the processing of instructions, controlling input and output devices, facilitating networking, and managing files. Exemplary operating systems can comprise (i) Microsoft® Windows® operating system (OS) by Microsoft Corp. of Redmond, Wash., United States of America, (ii) Mac® OS by Apple Inc. of Cupertino, Calif., United States of America, (iii) UNIX® OS, and (iv) Linux® OS. Further exemplary operating systems can comprise (i) iOS™ by Apple Inc. of Cupertino, Calif., United States of America, (ii) the Blackberry® OS by Research In Motion (RIM) of Waterloo, Ontario, Canada, (iii) the Android™ OS developed by the Open Handset Alliance, or (iv) the Windows Mobile™ OS by Microsoft Corp. of Redmond, Wash., United States of America. Further, as used herein, the term “computer network” can refer to a collection of computers and devices interconnected by communications channels that facilitate communications among users and allow users to share resources (e.g., an interne connection, an Ethernet connection, etc.). The computers and devices can be interconnected according to any conventional network topology (e.g., bus, star, tree, linear, ring, mesh, etc.).

As used herein, the term “processor” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise a CPU or central computer system 101.

Various I/O devices such as a keyboard, mouse disk controller, a graphics adapter, a video controller, a keyboard adapter, a mouse adapter, a network adapter, and other I/O devices can be coupled to system 100.

A network adapter (not shown) can be suitable to connect system 100 to a computer network by wired communication (e.g., a wired network adapter) and/or wireless communication (e.g., a wireless network adapter). In some embodiments, the network adapter can be plugged or coupled to an expansion port (not shown) in system 100. In other embodiments, a network adapter can be built into system 100. For example, a network adapter can be built into system 100 by being integrated into the motherboard chipset, or implemented via one or more dedicated communication chips, connected through a PCI (peripheral component interconnector) or a PCI express bus of system 100.

Although many other components of system 100 are not shown, such components and their interconnection are well known to those of ordinary skill in the art. Accordingly, further details concerning the construction and composition of system 100 are not discussed herein.

Meanwhile, when system 100 is running, program instructions (e.g., computer instructions) stored on one or more of the memory storage device(s) of the various embodiments disclosed herein can be executed by a CPU. At least a portion of the program instructions, stored on these devices, can be suitable for carrying out at least part of the techniques, methods, and activities of the methods described herein. In various embodiments, system 100 can be reprogrammed with one or more systems, applications, and/or databases to convert system 100 from a general purpose computer to a special purpose computer.

Further, system 100 can have a variety of different form factors. In some embodiments, system 100 may comprise a single computer, a single server, or a cluster or collection of computers or servers, or a cloud of computers or servers. Typically, a cluster or collection of servers can be used when the demand on system 100 exceeds the reasonable capability of a single server or computer. In certain embodiments, system 100 may comprise an embedded system.

In many embodiments, central database 102 can comprise a structured (e.g., indexed) collection of data and can be managed by any suitable database management systems configured to define, create, query, organize, update, and manage a database. Exemplary database management systems can include MySQL (Structured Query Language) Database, PostgreSQL Database, Microsoft SQL Server Database, Oracle Database, SAP (Systems, Applications, & Products) Database and IBM DB2 Database.

Meanwhile, central database 102 can be stored on one or more memory storage devices (e.g., non-transitory memory storage device(s)), which can be similar or identical to the one or more memory storage device(s) (e.g., non-transitory memory storage device(s)) described above with respect to system 100. In some embodiments, the memory storage device(s) of central computer system 101 can comprise some or all of the memory storage device(s) storing central database 102. In further embodiments, some of the memory storage device(s) storing central database 102 can be part of one or more third-party computer systems (i.e., other than central computer system 101), and in still further embodiments, all of the memory storage device(s) storing central database 102 can be part of one or more of the third-party computer system(s). When applicable, each of the third-party computer system(s) can be similar or identical to system 100. Notably, the third-party computer systems are not shown at FIG. 1 in order to avoid unduly cluttering the illustration of FIG. 1, and central database 102 is illustrated apart from central computer system 101 to better illustrate that central database 102 can be stored at memory storage device(s) of central computer system 101 and/or the third-party computer system(s), depending on the manner in which system 100 is implemented.

In many embodiments, central computer system 101 can be configured to communicate with central database 102. Communication between central computer system 101 and central database 102 can be implemented using any suitable manner of wired and/or wireless communication 110. Accordingly, system 100 can comprise any software and/or hardware components configured to implement the wired and/or wireless communication. Further, the wired and/or wireless communication can be implemented using any one or any combination of suitable wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), Powerline network protocol(s), etc.). Exemplary PAN protocol(s) can comprise Bluetooth, Zigbee, Wireless Universal Serial Bus (USB), Z-Wave, etc. Exemplary LAN and/or WAN protocol(s) can comprise Data Over Cable Service Interface Specification (DOCSIS), Institute of Electrical and Electronic Engineers (IEEE) 802.3 (also known as Ethernet), IEEE 802.11 (also known as WiFi), etc. Exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

In many embodiments, system 100 can communicate with and/or comprise one or exterior devices 103. Exterior devices 103 can comprise third party systems, as disclosed herein, as well as mobile electronic devices. A mobile electronic device can refer to a portable electronic device (e.g., an electronic device easily conveyable by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). A mobile electronic device can be a third-party system or owned or controlled by system 100.

Exemplary mobile electronic devices can comprise (i) an iPod®, iPhone®, iTouch®, iPad®, MacBook® or similar product by Apple Inc. of Cupertino, Calif., United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, Calif., United States of America, (ii) the Blackberry® operating system by Research In Motion (RIM) of Waterloo, Ontario, Canada, (iii) the Palm® operating system by Palm, Inc. of Sunnyvale, Calif., United States, (iv) the Android™ operating system developed by the Open Handset Alliance, (v) the Windows Mobile™ operating system by Microsoft Corp. of Redmond, Wash., United States of America, or (vi) the Symbian™ operating system by Nokia Corp. of Keilaniemi, Espoo, Finland.

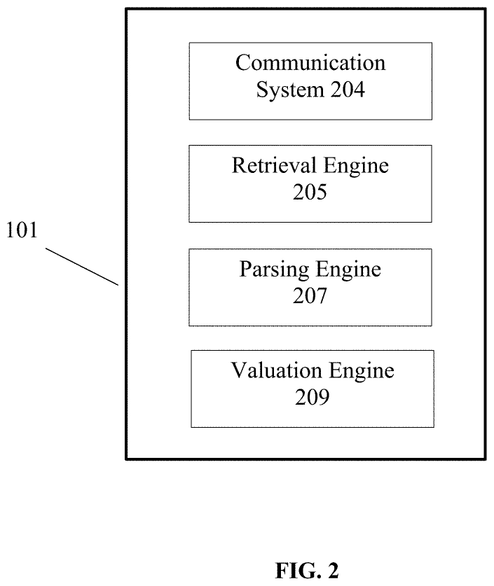

In many embodiments, and with respect to FIG. 2, central computer system 101 can comprise a communication system 204, a retrieval engine 205, a parsing engine 207 and a valuation engine 209. In some embodiments, part or all of communication system 204 can be part of retrieval engine 205, parsing engine 207, and/or valuation engine 209, and vice versa.

Communication system 204, retrieval engine 205, parsing engine 207 and valuation engine 209 can be implemented with hardware and/or software, as desirable. In many embodiments, part or all of communication system 204, retrieval engine 205, parsing engine 207 and valuation engine 209 can be stored at a memory storage device(s) and can be called and run at processor(s) 101, such as, for example, when the part or all of communication system 204, retrieval engine 205, parsing engine 207 and valuation engine 209 are implemented as software.

In many embodiments, communication system 204 can be configured to provide and manage communication between the various elements of central computer system 101 and manage incoming and outgoing communications between central computer system 101 and central database 102. For example, as applicable, communication system 204 can permit processor(s) 101 to call (i) software and/or data (e.g., at least part of retrieval engine 205, parsing engine 207 and valuation engine 209, etc.) stored in memory at processor 101 (or elsewhere as disclosed herein) and/or (ii) software and/or data stored at device(s) 103 and/or in central database 102.

For example, a user can use user electronic device 103 to access media that is hosted at one or more third-party computer systems. In particular, electronic device 103 can be configured to retrieve, traverse, and present data or media (e.g., streaming video data, web pages having video data, and networked video data) and/or related metadata via communication system 204. For instance, a video player, a web browser or any suitable media system can be used at user electronic device 103 to access the data, media and/or metadata. Further, user electronic device 103 can be configured to provide and/or present the data or media to a user through an electronic display. Further still, where the data or media comprises video data, the video data can be displayed at the electronic display (e.g., at a window of the electronic display and/or at a full screen of the electronic display, as embedded in another application format, and/or as part of a website). For instance, many websites offer media hosting services to users of the websites (e.g., a user via communication system 204). Consequently, users can access one or more websites via user electronic device 103 to access data, media and/or metadata.

Furthermore, a user can use user electronic device 103 to use retrieval engine 205 to search for media (e.g., data, media and/or metadata). In many embodiments, retrieval engine 205 and/or parsing engine 207 can catalogue the data, media and/or metadata from any number of sources (e.g., websites, social networks, devices 103, etc.) and generate and/or populate database 102 with information based thereon.

In one embodiment, using system 100 and/or retrieval engine 205, a user can view video data on a third party video hosting website (e.g., YouTube®, Facebook®, Twitter®, etc.) and search for a related videos.

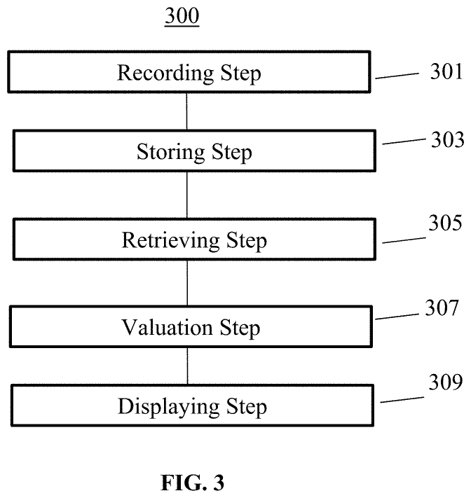

Turning ahead now in the drawings, FIG. 3 illustrates a flow chart for an embodiment of a method 300. Method 300 is merely exemplary and is not limited to the embodiments presented herein. Method 300 can be employed in many different embodiments or examples not specifically depicted or described herein. In some embodiments, the activities of method 300 can be performed in the order presented. In other embodiments, the activities of the method 300 can be performed in any other suitable order. In still other embodiments, one or more of the activities in method 300 can be combined or skipped.

In many embodiments, method 300 can be implemented via execution of computer instructions configured to run at one or more processors and configured to be stored at one or more non-transitory memory storage devices. In some embodiments, the processor(s) can be similar or identical to the processor(s) described above with respect to system 100 (FIG. 1), and/or the non-transitory memory storage device(s) can be similar or identical to the non-transitory memory storage device(s) described above with respect to system 100 (FIG. 1). Further, the processor(s) and/or non-transitory memory storage device(s) can be part of a central computer system, which can be similar or identical to central computer system 101.

In many embodiments, method 300 can comprise a step 301 of recording data into a data file. The data file can be any form of data file, including, but not limited to video files, text files, electronic emails, audio files, and the like. In some embodiments, data is recorded into a data file using a handheld device 103.

For example, in some embodiments, a vehicle owner can record a video describing the history of the vehicle using a cell phone as an exterior device 103. By describing the vehicle history, the vehicle owner can explain details about, for example, when and where the vehicle was purchased, how long the user owned the vehicle, how often the vehicle's oil was changed, any car accidents that the vehicle was involved in, the general annual mileage of the vehicle, any quirks, benefits or other traits of the vehicle, any repair history of the vehicle, any items that might need attention before the vehicle is resold, or any other information relevant to the vehicle's history.

As used herein, a vehicle owner refers to an owner of a vehicle, a mechanic, a person who has serviced a vehicle, dealership personnel, a person who has inspected a vehicle from, for example, the customer or sources other than a customer (i.e. off lease, rental car companies, corporate car programs, etc.), and the like. For example, in some embodiments, a mechanic can inspect a vehicle and create a video explaining the results of the inspection. In these embodiments, it may be desirable to have video testimony from someone who is not emotionally or financially invested in the vehicle to provide information about the vehicles status, repair history, functionality and the like.

In many embodiments, method 200 comprises a step 203 of storing the data file (i.e., a video file, and/or related metadata) in one or more portions of database 102. Communication system 204, retrieval engine 205, and/or parsing engine 207 can be used to store the data in one or more portions of database 102.

For example, in some embodiments, parsing engine 207 can parse a data file into smaller files for storage in database 102. Parsing engine 207 is software and/or hardware that can convert a data file from one format to another and/or break the data file into one or more sub-parts. For example, with a video file, parsing engine 207 can convert the video file to a text portions, audio portions and/or image portions, such that each frame or sequence of video frames can have an audio portion, image portion and/or text portion associated therewith. The audio portion of the video can be converted into a text portion that has optical text recognition features, such that the data file can be sorted, searched for, saved and/or classified based upon the recognized characters.

For example, in some embodiments, if the data file is a video file that contains a history of a vehicle, parsing engine 207 can convert the audio portion of the video file can also be converted to a text file, such that the video file can be parsed and/or stored based upon metadata or text of the audio file portion. For example, if a vehicle owner describes a car accident that the vehicle was involved in, that portion of the video can be parsed based upon the use of the words “car accident” in the audio portion of the video. In other embodiments, parsing engine 207 can separate a data file, such as a video file, into multiple files. With reference to the vehicle history example, the parsing engine 207 can separate the video file into multiple files, including but not limited to a vehicle purchase file, a vehicle repair file and a vehicle accident file, and the like, based upon the recognizable text data associated with the parsed video file. In many embodiments, after any file parsing and/or conversions have occurred, the data file or files can be stored in one or more portions of database 102.

In some embodiments, parsing engine 207 can employ recognition technology to group and classify similar language phrases together. For example, in the “car accident” example above, if the vehicle owner says “fender bender” or “hit” or “crash”, these words can all be recognized and classified together as “accidents.”

In some embodiments, two or more data files for a vehicle may be compiled together, providing a complete vehicle history.

In some embodiments, the database 102 can be accessed by third parties, for example, by a subscription or other arrangement. Similarly, multiple parties can use a central database to store all vehicle data files, such that any party can gain access and retrieve a data file by accessing the retrieval engine 205 that retrieves information from a central database 102.

For example, in some embodiments, method 300 comprises a step 305 of retrieving some or all portions of the data file from database 102. Again, communication system 204 and/or retrieval engine 205 can be used to retrieve data from one or more portions of database 102. For example, in one embodiment, retrieval engine 205 can be used to retrieve accident history of a vehicle, using key words such as “accident”, “crash” or “wreck” or the like. Retrieval engine 205 can retrieve any data file (or portion thereof) that contains all or a portion of the key words.

In some embodiments, as part of the retrieving step, communication system 204 can communicate the data file to one or more third parties. For example, in one embodiment, communication system 204 communicates accident history information, such as a video file describing a vehicle's accident history, to a third party such as Carfax, Auto check, Kelly Blue Book or other vehicle evaluation service.

In other embodiments, as part of the retrieving step, communication system 204 can retrieve pricing information from one or more third parties to use in a valuation step 307.

In many embodiments, valuation engine 209 can calculate pricing for a vehicle based upon certain information in the data files in database 102. For example, if a vehicle video file indicates that a vehicle has been in a minor fender-bender and had the bumper repaired by a dealer, valuation engine 209 can calculate a minimal deduction in the vehicle's price. By calculating a price, valuation engine 209 can interact with pricing software and/or a pricing database (not shown), that contains information from third-party pricing guides (such as, for example, Kelly Blue Book or Carfax) regarding pricing guidelines for various vehicles. By interacting with the pricing software and/or a pricing database, valuation engine 209 can calculate a more-accurate pricing based upon a vehicle's history. For example, whereas a third-party pricing guide may deduct 12-20% of a vehicles trade-in value if it has been in a “reported accident,” valuation engine 209 can access data files from database 102 to determine that the “reported accident” for a particular vehicle was only a minor fender-bender and that appropriate repairs were made. Accordingly, valuation engine 209 can calculate a trade-in value that has a lower deduction from the “reported accident” than 12-20%.

In other embodiments, valuation engine 209 can use one or more algorithms to derive a valuation for a vehicle. In some embodiments, the algorithms include pricing information from a third party such as Carfax, Auto check, Kelly Blue Book or other vehicle evaluation service, as well as information from one or more data files. For example, in some embodiments, information from data files regarding a vehicle's maintenance history, accident history, driving conditions and/or the like may be assessed certain valuation factors used in an algorithm to assess the vehicle valuation. For example, in one such example, a vehicle's valuation, V, is the result of a standard third party valuation of the vehicle, T, multiplied by an accident value, a, a maintenance history value, m, and a driving conditions value, d, as shown below:

V=T*a*m*d

In addition, a customer can see the video or data evidence supporting the vehicle's calculated value. For example, in some embodiments, method 300 comprises a step of displaying 307 the data file to a user. For example, a user can use a device 103 to access a data file, such as a video file regarding a vehicle using communication system 204 and/or retrieval engine 205. In some embodiments, after retrieval engine 205 retrieves the file and communicates it to the user, the communication system 204 and/or retrieval engine 205 can facilitate displaying the video file to the user on device 103.

In other embodiments, system 100 can employ valuation engine 209 to evaluate the data files in database 102 to learn of certain trends in the data. For example, system 100 may evaluate the data files to discover common repairs made to a specific make and model of vehicle. That way, valuation engine 209 can estimate future vehicle repair costs and provide this information to a customer/user. System 100 can use communication system 204 to communicate any trends discovered to one or more third parties and/or users that may own, sell or have sold that type of vehicle.

Computer processing system 101 can also use communication system 204, retrieval engine 205, parsing engine 207 and/or valuation engine 209 to access and share information regarding a vehicle from database 102 to third-parties to enable more accurate pricing of vehicles. In some embodiments, computer processing system 101 can provide access to data and/or vehicle information through a cloud-based software platform. In other embodiments, the data and/or vehicle information can be transmitted directly to a third party through a device 103 and/or any other type of third-party computing system.

Although the invention has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-3 may be modified, and that the foregoing discussion of certain of these embodiments does not necessarily represent a complete description of all possible embodiments. For example, one or more of the activities of the methods described herein may include different activities and be performed by many different elements, in many different orders. As another example, the elements within computer system 100 can be interchanged or otherwise modified.

Generally, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a processor; and
an input to the processor for receiving a data file containing vehicle specific information;
a retrieval engine for storing and retrieving the data file;
wherein the retrieval engine is configured to parse the data file before storing.

2. The system of claim 1, further comprising a valuation engine for determining a value of a vehicle using the data file.

3. The system of claim 2, wherein the valuation engine determines the value of the vehicle using the data file and third-party vehicle pricing information.

4. The system of claim 1, wherein the data file is a video file.

5. The system of claim 1, wherein the data file comprises at least two of a video file, text file, electronic email, and audio file.

6. The system of claim 4, further comprising a parsing engine for converting the video file to a vehicle purchase file, a vehicle repair file and a vehicle accident file.

7. The system of claim 1, wherein at least one of metadata, text information, and audio information can be parsed from the data file.

8. The system of claim 4, further comprising a parsing engine for parsing the video file into a text file, an audio file and an image file, wherein the text file, audio file and image file are all associated with one another.

9. A method of providing vehicle valuation information, comprising:
receiving recorded information about a vehicle;
parsing the recorded information into a data file;
storing the data file in a database;
retrieving a data file from the database; and
displaying the data file as part of a vehicle valuation.

10. The method of claim 9, further comprising valuating a value of a vehicle using one or more data files.

11. The method of claim 10, further comprising determining the value of the vehicle using the data file and third-party vehicle pricing information.

12. The method of claim 9, wherein receiving recorded information about a vehicle comprises receiving a video file.

13. The method of claim 9, wherein the parsing the recorded information into two or more data files comprise parsing the recorded information into at least two of a video file, text file, electronic email, and audio file.

14. The method of claim 12, further comprising parsing the video file into a vehicle purchase file, a vehicle repair file and a vehicle accident file.

15. The method of claim 9, further comprising parsing the recorded information into at least one of a metadata data file, a text data file, and an audio data file.

16. The method of claim 12, further comprising parsing the video file into a text file, an audio file and an image file, wherein the text file, audio file and image file are all associated with one another.
